(19) United States
(12) Patent Application Publication
(10) Pub. No.: US 2014/0214674 A1
(43) Pub. Date: Jul. 31, 2014

(54) METHOD AND SYSTEM FOR CONDUCTING SECURE TRANSACTIONS WITH CREDIT CARDS USING A MONITORING DEVICE

(71) Applicant: RELIANCE COMMUNICATIONS, LLC., Hauppauge, NY (US)

(72) Inventor: Mike Narula, Sands Point, NY (US)

(73) Assignee: RELIANCE COMMUNICATIONS, LLC., Hauppauge, NY (US)

(21) Appl. No.: 14/061,026

(22) Filed: Oct. 23, 2013

Related U.S. Application Data
(60) Provisional application No. 61/839,958, filed on Jun. 27, 2013.
(60) Provisional application No. 61/757,789, filed on Jan. 29, 2013.

(51) Int. Cl. G06Q 20/40

(52) U.S. Cl. CPC G06Q 20/405
USPC 705/44

(57) ABSTRACT

A system is presented for performing secure transactions, the system including a payment member, such as a payment card, a monitoring device monitoring that the payment member is physically near the monitoring device and a portable communication device, such as a cell phone, used to communicate with a credit card server. The monitoring device checks to see if it can establish a close range communication link with the payment member and the sends information to the credit card server permitting transactions to be completed. The customer associated with and carrying the payment member, the monitoring device and the portable communication device is authenticated using a biometric sensor in the monitoring device.

### RELATED APPLICATIONS

This application claims priority to U.S. Provisional Applications Ser. No. 61/757,789 filed Jan. 29, 2013 and Ser. No. 61/839,958 filed Jun. 27, 2013, both incorporated herein by reference.

### BACKGROUND OF THE INVENTION

A. Field of Invention

This invention pertains to a method and system for performing secure transactions either in a regular or virtual store. Before a transaction for a product or service is approved, a check is performed to determine if a payment instrument (that could be a credit card or a portable device) is in close physical proximity to a monitoring device and otherwise the transaction is not permitted.

B. Description of the Prior Art

The present invention involves a method and system for conducting transactions, e.g., buying products or services, with a credit card, mobile device, or other similar means. The term ‘credit card’ is used generically to cover various different cards that can be used to make payments, including cash cards, debit cards, and so on.

Credit cards have become so convenient, widely available and accepted that many people use them almost exclusively to pay for goods and services. Of course, online stores can only accept some kind of credit card as a payment mean.

Unfortunately, fraudulent transactions involving credit cards have also become very common. It has been estimated in recent years that 10% if the customers in the United States have been victims of some kind of fraud related to credit cards. While the banks, credit card companies, and police departments are aware of these activities, due to lack of man power and other factors, there is very little effort being made to prevent such activities. Typically, merchants may be reimbursed for loses due to credit card fraud by insurance companies, but are still negatively affected by such fraud because of the manpower required to handle credit card fraud, irate customers, loss to their reputation, etc.

In addition, although the liability of customers is limited, at least in the United States by law, a customer who is victim of fraud is still inconvenienced by the paper work required to correct such matters, possible refusal of goods or services, especially if the customer is far from home, as well as injury to his/her reputation and possible negative effects on his credit scores.

Thus, there is a need for a system and device to eliminate or at least reduce the incidence of fraudulent credit card activities. Such a system would not only be helpful to customers but also to the merchants providing goods or services to the customers as well as the banks and credit card companies that issue the credit cards to the customers.

### SUMMARY OF THE INVENTION

Briefly, the present system in one embodiment includes a payment member such as a payment card for paying for a transaction, a monitoring device and a communication device. Before transactions are completed, the monitoring device checks if the payment member and communication device are physical close to the monitoring device or not. Preferably this is accomplished by using a limited communication link using for example but not limited to, a Bluetooth communication protocol (including BT 4.0, Bluetooth Low Energy, iBeacon etc.), NFC, or RFID. Preferably, the elements of the system include a biometric sensor for authenticating the customer associated with the payment member and the monitoring device. The communication device is used to exchange information during the transaction process with remote servers, such as a credit card server. The communication device can also suggest a fraud based on exchanged information either via a 3^{rd} party application, break the communication link, or rewriting information on payment member via RFD. The system and method can be used to perform transactions in real stores or virtual stores over the Internet.

Once a transaction is authorized, it may be completed using conventional techniques, e.g., by scanning the payment member, or using an NFC protocol.

In an alternate embodiments of the invention, either the payment member or the monitoring device may be incorporated into the communication device.

### BRIEF DESCRIPTION OF THE DRAWINGS

FIG. 1 shows schematically a system for effectuating transactions in accordance with this invention;

FIG. 2 shows a somewhat diagrammatic illustration of a network in which the system of FIG. 1 is used by a customer to obtain goods or services from participating real or virtual stores;

FIGS. 3A and 3B show a flow chart illustrating the operation of the system of FIGS. 1 and 2;

FIG. 4 shows an alternate embodiment in which the communication device includes an NFC module;

FIG. 5 shows an alternate embodiment in which the payment member, e.g., the credit card is omitted and the communication device performs the functions of the payment device;

FIG. 6 shows another alternate embodiment in which the monitoring device is incorporated into the communication device; and

FIG. 7 shows another alternate embodiment in which the monitoring device acts as the payment member, the credit card being omitted.

### DETAILED DESCRIPTION OF THE INVENTION

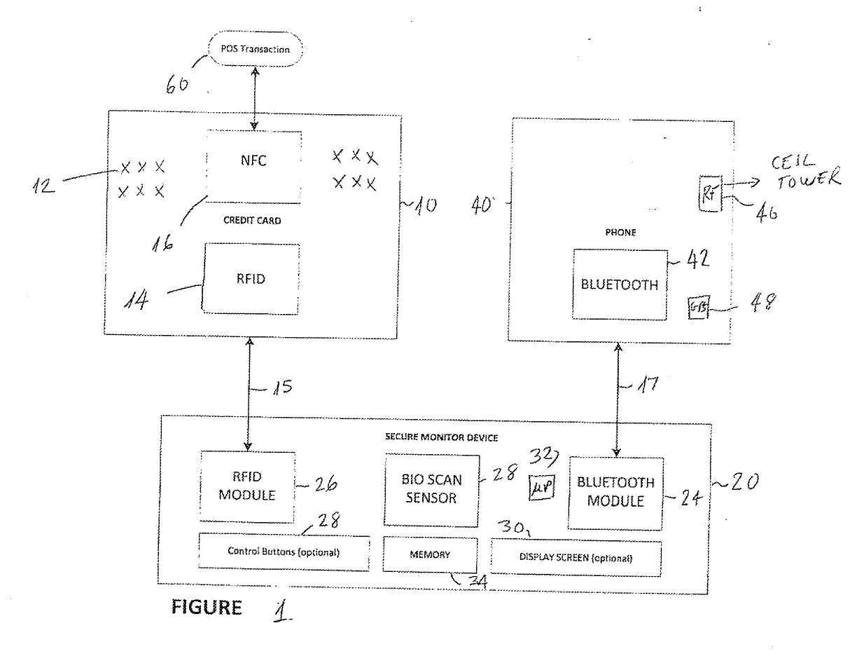

As previously described, the present application pertains to a method and system for performing financial transactions (e.g., payments for goods and services) using a payment card, For this purpose, system 100 includes a payment member such as a payment card 10 shown in FIG. 1. In this application the term payment card and credit card are used interchangeable however it should be understood that the payment card can be cash card, a debit card, a credit card, etc.

The card 10 may have the same size, shape and characteristics as conventional cards. For example, the card 10 may be imprinted with the conventional information 12, such as the name of the issuing entity, the name of the customer, a card number, expiration date, etc. Importantly, an electronic means is provided for detecting and/or identifying the card 10. For example, the card 10 may include an RFID chip 14 and/or an NFC chip 16 The RFID may be either an active or a passive device.

In one embodiment of the invention, the system 50 further includes a secure monitoring device 20. Device 20 is a portable device that includes several modules and a microprocessor 32 controlling the modules.

The monitoring device may be implemented or incorporated into various accessories (such as key fob, wrist band, clip, tether, etc. . . . ) to give the consumer various options. As shown in FIG. 1, the monitoring device 20 includes a Bluetooth module 24, an RFID transceiver module 26 adapted to communicate with the RFID chip 14 on the payment card 10 and a biometric sensor module 28. The module 28 is used a unique characteristic of the consumer, such as his fingerprints or other means of identifying the consumer.

The consumer can enter information or commands to device 20 on control buttons 30 (including, optionally a keyboard) and instructions and other information may be displayed on a screen 30. Various data is stored within device 20 in memory 34. Screen 30 may be a touch screen, in which case the control keys 28 may be virtual. The monitoring device may further include other standard elements, such as speakers (can alert user when permissible range is exceeded to ensure they don't forget pone and/or credit card), microphones, etc.

Typically the customer also has cell phone or other similar conventional communication device. The system uses the cell phone in conjunction with the payment card and the monitoring device as described below. The cell phone should have at least one short range communication channel such as Bluetooth and preferably NFC to establish communication with credit card 10 and optionally with a point of sale (POS) device 60 as described below. The cell phone 40 also includes an RF communication module 43 providing cell phone communication and optionally a GPS module 48. The GPS module 48 can be used to report the current geographical location and status of the customer in proximity to the monitoring device 20 and/or payment card 10.

To summarize, the present invention in one embodiment includes three elements: a payment card 10, a monitoring device 20 and a cell phone 40, with both the cell phone 40 and the payment card 10 being in short range communication with the monitoring device. As mentioned above, preferably, the short range communication between the monitoring device 20 and the payment card 10 is implemented an RFID protocol. The term short range communication link is used herein to refer to a link that is short enough to indicate, when present that the relevant elements, e.g., the payment card and the monitoring device are either worn or carried by the customer or otherwise close to each other. In other words, the link may have a range of 1-20 feet.

The cell phone 40 communicates with the monitoring device via short range Bluetooth protocol (such as but not limited to BT4.0, Bluetooth Low Energy, iBeacons, etc.). Of course, these protocols can be reversed, e.g., Bluetooth may be used between the monitoring device 20 and the payment card 10 and RFID may be used between the monitoring device and the cell phone 40. In another embodiment, all communication between these elements is performed using the same protocol such as RHO, Bluetooth or NFC. In addition, when a customer is near a point of sale (POS) unit 60, communication may be established between the payment card 10 or cell phone 40 and the point of sale device 80.

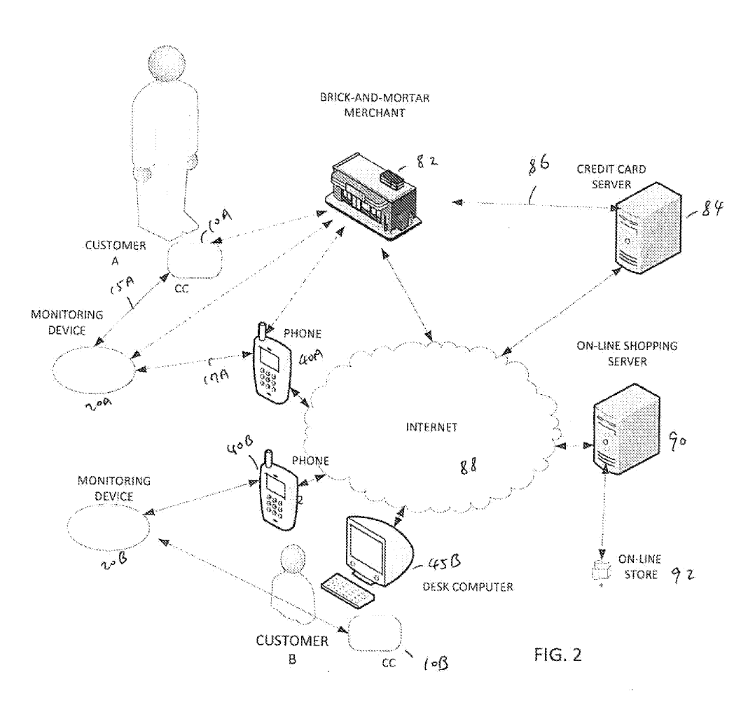

FIG. 2 shows somewhat diagrammatically the environment 80 in which the system is used. As discussed above, typically customers are in the possession of a payment card 10A, a monitoring device 20A, and mobile cell phone 40A. In a first example, a customer A visits a brick-and-mortar merchant 82 and buys an article or service, paying with either his payment card 10A, mobile device 40A, or monitoring device 20A. The system goes through a process to ensure that the customer A is a person validly associated with the payment member before the payment card is charged and the transaction is complete, as described in more detail below.

The transaction is performed by a credit card server 84, with communications taking place either through direct dedicated lines, such 86 or the Internet 88.

Customer B visits the website of an on-line merchant 92 (associated with an online shopping server 92) and buys another item or service. This process is performed either via the cell phone 40B associated with customer B, or via a desk top computer 45B. The customer uses his payment card 10B to make the purchase and the process is monitored by the monitoring device 20B. A slightly different process is performed to verify this transaction, as described in more detail below, but the transaction is again performed through the credit card server, preferably over the Internet 88. The various elements described and shown in FIG. 2 communicate either directly with sonic of the other elements, or indirectly through the Internet as described.

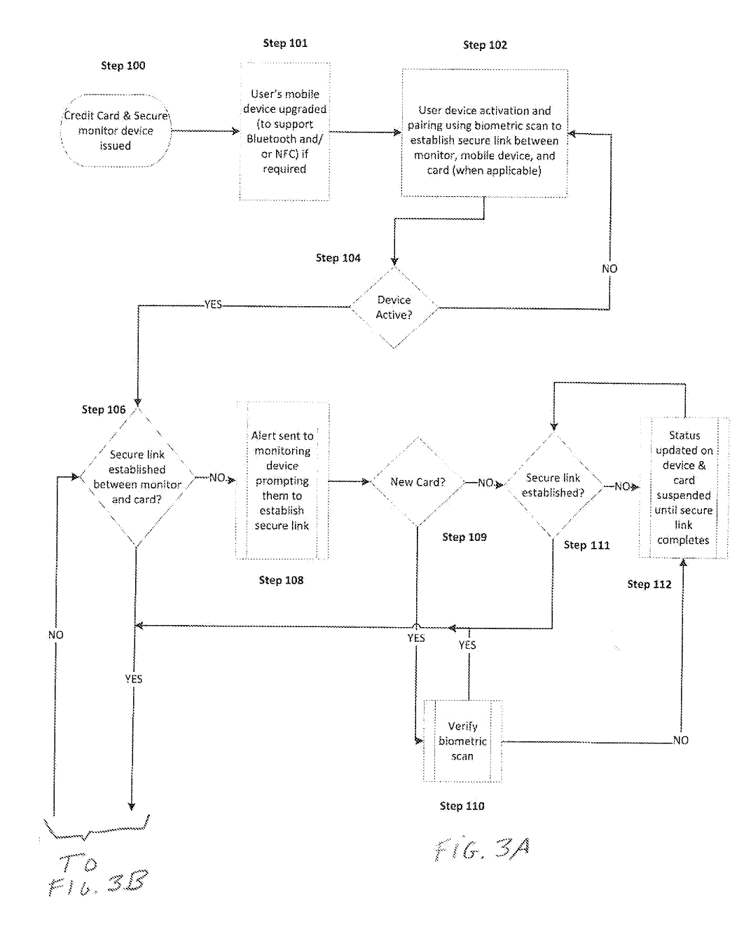

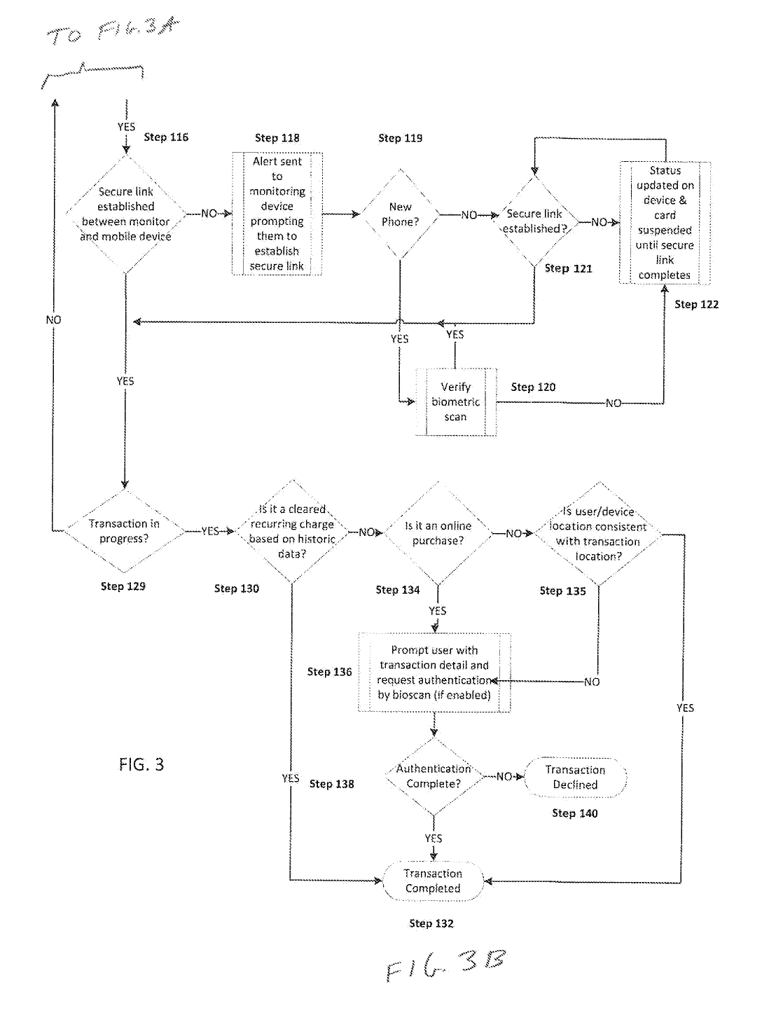

FIGS. 3A and 3B shows a flow chart describing the preferred operation of the system 50. In step 100 a customer, for example, customer A is provided with a payment means, such as a credit card 10A and a monitoring device 20A by the credit card issuing entity. Next, the customer's cell phone is checked to make sure that it is compatible with system 50 and upgraded, if necessary (step 101). The monitoring device 20A is then activated and set for an initializing or activation subroutine stored therein (step 102). During this subroutine, the customer may be required to enter or automatically provide his or her unique information, such as mailing address, email address, credit card information, etc. The biometric module (if any) is also initialized and the customer allows the biometric module to read an initial biometric signature (such as his/her fingerprint) that is to be used to authenticate the identity of the customer. This initial biometric signature is stored in memory 34 of monitoring device 20A. In other embodiments, this biometric signature may be stored remotely, for example in the credit card server 84, as well. During this step, the monitoring device 20 also makes contact with the credit card 10A and a dedicated communication link 15A is established therebetween. For example, if the credit card 10A is provided with an RFID chip 14, then the monitoring device 20A interrogates this RFID chip to confirm that the credit card 10A is close.

The monitoring device 20A also makes contact with the mobile device 40A and a dedicated communication link 17A is established therebetween. For example, if the mobile device 40A is provided with Bluetooth module 42, then the monitoring device 20A interrogates the mobile device Bluetooth module 42 to confirm that the mobile device 40A is close. As previously mentioned, preferably the link 15A to the credit card 10A is a short range link so if the credit card 10A is not nearby, no link can be established. If link 15A cannot be established between the monitoring device 20A and the mobile device 40A or credit card 10A, the monitoring device 20A goes into a dormant mode and waits to be activated (step 104). (It is preferred that this communication link needs to be authenticated by biometric module on monitoring device 40A, every time a communication link is establish with a new communication device).

The monitoring device 20A remains in a dormant mode until the customer visits brick and mortar merchant 82. Once there, when the customer A is ready to buy some goods or services, the monitoring device 20A is activated (step 106), the status of the dedicated communication link 15A between the monitoring device 20A and the credit card 10A is checked (step 106) and the status of the communication link 17A between the monitoring device 20A and mobile device 40A is checked. If either link is not active, in step 108 an alert is generated to the customer A to indicate that there is no contact with either of these elements. For example, the customer A may not have his credit card 10A with him. When the credit card A is found, the process for linking to it is again initiated, and as part of this process, the customer A is requested for a scan by the biometric module 28. For example, the customer A may provide his fingerprint which is then checked against the biometric signature of record, (for example if customer is trying to establish a link between the monitoring device 20A and a new credit card 10A). If customer A is verified through the biometric device 28, then the secure link 15A is established.

If no link can be established to the credit card 10A (step 111), then a second alert is presented to the customer A (for example, by presenting a text message on the screen 30) and a message is sent to credit card server 84 to suspend the credit card transactions at least temporarily until the customer A can be authenticated (step 112).

While the credit card 10A is suspended, the credit card server 84 will refuse to accept any transactions associated with the credit card 10A. The monitoring device 20A may be provided with a status indication function, so that the customer A can check his/her device 20A and determine whether the associated credit card 10A is active, or not. In one embodiment, the ability to temporarily disable secure link 15A, and optionally link 15A may be integrated with a pre-defined timeout to ensure security is resumed after a set time period or date on the monitoring device 20A. In other words, the customer A may be given a time-out period to cure a problem and establish the proper links 15A, 17A. If these secure links are not established within the time-out period, the credit card 10A is suspended and re-initiation process may be required to re-instate the credit card 10A.

These steps can be performed either the monitoring device 20A or the credit card server 84. The monitoring device 20A and the credit card server 84 communicate with each other for this purpose, preferably through the cell phone 40A either directly or through the Internet 88.

(Similar steps to be taken to establish secure link, 17A, between monitoring device 20A and communication mobile device 40A, as shown in FIG. 3, from step 116 to step 122).

Getting back to steps 106-110, once a secure link ISA is established between the credit card 10A and the monitoring device 20A, (and secure link 17A is established between the monitoring device 20A and communication device 40A at step 122); the monitoring device 20A enters into a standby mode in which it looks for a transaction in progress (step 129). This step is performed by the credit card server 84 and can be initiated either manually by the customer A or automatically, for example, by the monitoring device 20A is detecting that the customer A is in a store of merchant 82, or the monitoring device 20A or cell phone 40A receiving a signal from a point of sale device 60 indicating that the POS device is close.

As described in more details below, during every transaction, the system 50 normally performs certain checks to insure that the customer A of the credit card 10A has been authenticated as an authorized customer. However, in order to speed some of the transaction processes, the customer A may designate certain transactions as being special transactions. For example, the customer A or the system 50 may elect transactions with certain known merchants that are repeat (recurring) transactions, that have cleared previously, or transactions involving small charges as special transactions.

Once a transaction in progress is detected in step 129, in step 130 the transaction is checked to determine if it is a special transaction or not. Special transactions are allowed to proceed to completion with no further interference and are completed by the credit card server 84 (step 132).

For conventional (not special) transactions, a determination is made as to whether the transaction is an online transaction or not (step 134). On line transactions are addressed below.

For transactions initiated in brick-and-mortar store 82, other tests may be performed before a transaction is allowed to proceed. For example, when a transaction is detected the location of customer A is determined using the GPS 48A from the linked mobile device 40A. This location is compared to the known location of the store (step 142). If the locations match, the transaction is completed (step 132). If the locations do not match, then the customer is required to authenticate (steps 136, 138) through the biometric module of the monitoring device, as discussed above If there is no customer biometric authentication, transaction is terminated either by reporting discrepancy to credit card server or communication device disconnecting secure link via 3^{rd} party app. Another test performed in step 135 includes checking whether a customer A is buying an object that may be found on an approved list, or is buying an article consistent with his or her profile. For example, the customer A may have indicated that he is a male or a profile may be established indicating that customer A is more likely to be a male. If customer A is now attempting to buy ladies underwear, in step 135 the transaction may be temporarily halted and the customer A may have to authenticate his identity in steps 136, 138 before the transaction is allowed to be completed (step 132).

In another scenario, customer B uses decides to buy some goods or services through the Internet 88. The customer B is also supplied with a credit card 10B, a monitoring device 20B and has a cell phone or other similar smart device 40B. These elements are initialized, set up for customer B and interlinked or paired as described above in steps 100-129.

For online transactions, customer B accesses an online merchant and requests an item or service. This process can be performed either on the desk top computer 45 B or on cell phone 40B (of the latter is a smart cell phone). The initiation of a buying process or application may be used as an indication that the transaction is in process (step 120) or customer B may indicate a transaction. Once the transaction is initiated, in step 134, an online merchant 92 requests authorization from the credit card server 84 (through online shopping server 90). The credit card server 84 sends a message to the mobile device 20B requesting authentication of the customer. The mobile device 20B alerts customer B that an authentication is required, so the customer B performs the biometric scanning on the monitoring device 20B as needed (e.g., fingerprinting) (step 136). The monitoring device 20B (or the credit card server 84) then compares the scanned biometric parameter with the stored biometric signature. If there is a match, the customer B is authenticated (step 138) and the transaction is completed (step 132).

If customer B is not authenticated in step 138 then the transaction is terminated (step 140) via the methods described above.

In this manner, each common transaction involving the credit card 10 or monitoring device 20 is closely tracked and is not allowed to be completed without authenticating the customer A initially when the system is set up, and additionally during the transaction, if required. As part of this scheme, the customer A, B must have the credit card, the monitoring device, and the cell phone with him. In some instances related to brick-and-mortar stores 84, the geographic location of the store is compared with the location of the customer A as well for added security and/or other checks may be performed before completing a transaction.

The present invention thus solves many problems associated with conventional processes for performing transactions, including use of fraudulent transactions spoofing either the customer or the merchant.

The present invention may be used with different kinds of cell phones. As shown in FIG. 1, cell phone 40 may have only a Bluetooth transceiver 42. In this case, the communication link 17 between the cell phone 40 and the monitoring device takes place over the Bluetooth channel (of course, after appropriate pairing therebetween). Pairing between the monitoring device and the cell phone confirms that the two are close to each other (wherein the term “close” is defined by the Bluetooth protocol range). Typically, the phone may also have a GPS or other geographic locator 48 that can be used to determine the location of the user.

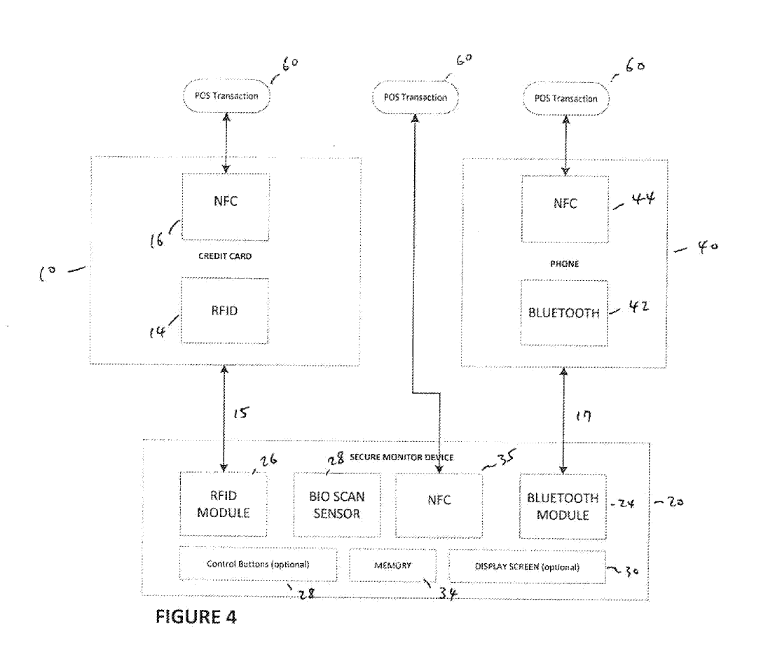

In FIG. 4, the cell phone is a more advanced unit that includes an NFC module 44 in addition to Bluetooth module 42. In this configuration, transactions can be performed either by scanning/communicating with credit card 10 or via the cell phone 40 to a PCS unit 60. Validation/authentication of the customer is still performed through the monitoring device 20.

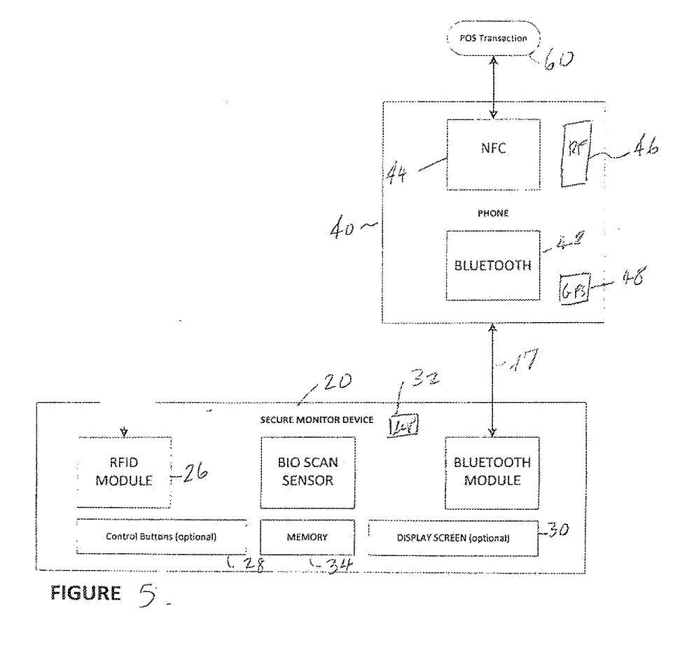

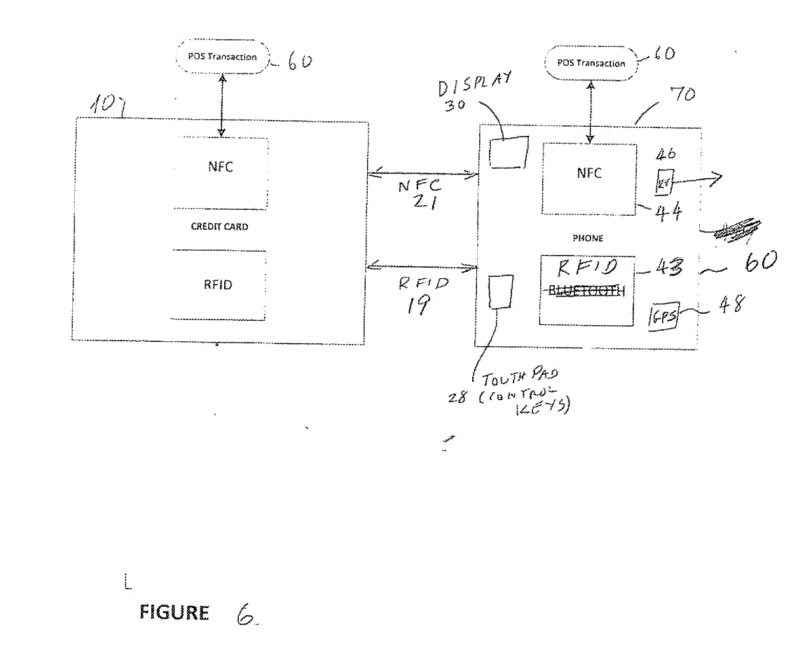

In another alternate embodiment, shown in FIG. 5 the cell phone 40 includes an NFC module is used for performing transactions through a POS unit 60 and the credit card 10 is no longer needed at all. In this configuration, the monitoring device 20 is still used to validate/authenticate the customer. In addition, valuable assets or possessions, as well as items of interest to the user (e.g., items that the user is interested in buying) may be tagged with an RFID, NFC or Bluetooth capability and recognized by the monitoring device using RFID module 26 or Bluetooth module 24. The monitoring device 20 can then relay this information to the mobile device 40 to an application that processes this information for diverse use cases including but not limited to asset tracking, promotional awareness and related advertising, or advanced purchase methodologies.

In another embodiment, a cell phone 60 including an RFID module 43 and optionally an NFC module 44 is used to perform the functions of both the monitoring device 20 and the cell phone 40. In other words, the monitoring device 20 and the cell phone 40 are combined into a single device 60. Communication is established to credit card 10 either through an RFID link 19 or through an NFC link 21. Transactions are then performed as described in FIGS. 2 and 3 but using a cell phone 60.

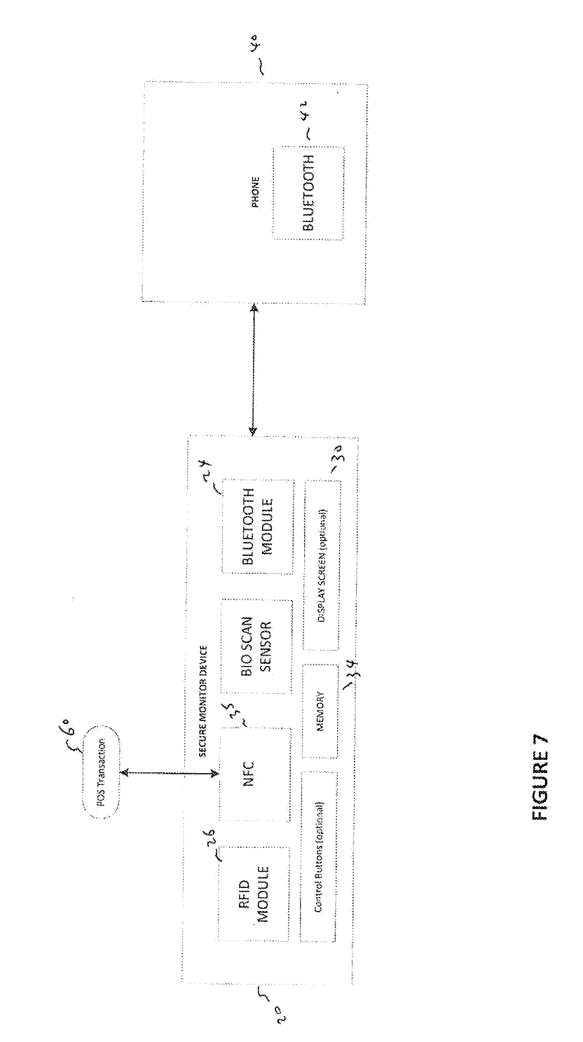

In an alternative embodiment shown in FIG. 7, the monitoring device includes an NFC module 35. Monitoring device and cell phone can establish link using Bluetooth. Both Monitoring device and cellphone can be used as a payment member via NFC technology.

The system may be used for other functions as well. For example, the credit card server or another similar entity may keep track of the movement of the customer in a shopping center or mall and used to derive a profile for the customer indicative of his/her likes and dislikes. If the customer stops, for example, to window shop at shoe stores and bookstores, the customer's profile is augmented to indicate that the customer likes shoes and books. Then at future times, e.g., when the customer is using the desk top computer or even browsing on his or her smart phone (that may include the monitoring device) his or her profile may be used to select ads and these ads are then presented to the customer. This data may also be used for suggesting or pushing related applications to the user of their device. This can take the form of a mobile concierge. Other independent sensors (pedometer, etc.—not shown) may interface with the application, giving potential promotional data to the participating credit card providers. Participating users may benefit through credits or promotions on associated products or services. The monitoring device may also integrate memory for storing user credentials or medical history, which can then be secured by the link and reliably shared during appointments with rare providers.

Numerous modifications may be made to this invention without departing from its scope as defined in the appended claims.

I claim:

1. A method for performing transactions between a customer and a merchant, wherein the customer having a payment member associated with a credit card server, said customer further being associated a monitoring device, said method comprising the steps of:
receiving by the monitoring device an indication of a transaction between the customer and the merchant;
checking by the monitoring device whether there is a short range communication link between the monitoring device and the payment member, said short range communication link when established indicating that the monitoring member and the payment member are physically close to each other; and
transmitting by said monitoring member an authorizing command to said credit card server to permit the transaction to be completed in the presence of said short-range communication link.

2. The method of claim 1 wherein the customer is also associated with a cellular phone wherein in another communication link is established between the cell phone and the monitoring device further comprising performing communications between said monitoring device and the credit card server through said cellular phone.

3. The method of claim 1 wherein the monitoring device includes a biometric sensor adapted to monitor a biological parameter of the customer, further comprising performing a check by the biometric sensor before the transaction is completed to authenticate the customer.

4. The method of claim 3 further comprising the step of performing a check by said monitoring device to determine if a predetermined condition exists and if said predetermined condition does not exist, authenticating the customer with said biometric sensor if said predetermined condition does not exist.

5. The method of claim 4 wherein said predetermined condition includes a predetermined geographical location.

6. The method of claim 1 further comprising initializing the monitoring device and the payment member to customize the monitoring device and the payment member to the associated customer.

7. The method of claim 3 further comprising an initializing stage during which a biological parameter characteristic of the customer is obtained by the biometric sensor and used as a biometric signature stored in one of the monitoring device and the credit card server.

8. The method of claim 1 wherein said transaction is associated with a real store with the customer being in the real store.

9. The method of claim 1 wherein said transaction is associated with a virtual store.

8. A system for conducting secure transactions by a customer comprising:
a payment member including a first short range communication transceiver and customer; and
a monitoring device including a second short range communication module selectively establishing a short communication link with said payment member and a long range communication module, said monitoring device being adapted to detect when said short communication link is present with said payment member, said monitoring device being adapted to authorize a transaction associated with said payment member over said long range communication module when said short communication link is present.

10. The system of claim 9 wherein said monitoring member includes a biometric sensor selectively sensing a biometric characteristic of the customer, said monitoring device being adapted to authorize the transaction when the biometric characteristic meets a predetermined criteria.

11. The system of claim 9 further comprising a portable communication device including a third short range communication module selectively communicating with said monitoring device and transmitting from said monitoring device information to a remote server via cellular network.

12. The system of claim 9 wherein said payment member is one of a credit card, a debit card and a cash card.

13. The system of claim 9 wherein said payment member includes an RFID chip.

14. The system of claim 13 wherein said payment member further includes a NFC chip.

15. The system of claim 14 wherein said payment member is adapted to perform transactions with a respective POS device through said NFC chip.

16. The system of claim 11 wherein said payment member is incorporated in said portable communication device.

17. The system of claim 11 wherein said monitoring device is incorporated into said portable communication device.

18. The system of claim 11 wherein said monitoring device includes NFC technology which can act as a payment member.
